(19) United States
(12) Patent Application Publication
(10) Pub. No.: US 2008/0212411 A1
(43) Pub. Date: Sep. 4, 2008

(54) PROGRAMMABLE TIME SIGNAL RECEIVER, METHOD FOR PROGRAMMING A TIME SIGNAL RECEIVER, AND PROGRAMMING DEVICE FOR TIME SIGNAL RECEIVERS

(76) Inventors: Christian Polonio, Heilbronn (DE); Roland Polonio, Neckarsulm (DE); Hans-Joachim Sailer, Heilbronn (DE)

Correspondence Address: Muncy, Geissler, Olds & Lowe, PLLC, P.O. BOX 1364, FAIRFAX, VA, 22038-1364, US

(21) Appl. No.: 11/962,087

(22) Filed: Dec. 20, 2007

Related U.S. Application Data
(60) Provisional application No. 60/876,530, filed on Dec. 22, 2006.

(30) Foreign Application Priority Data
Dec. 20, 2006 (DE) 102006060925

(51) Int. Cl. G04C 11/02

(52) U.S. Cl. 368/47

(57) ABSTRACT

A programmable time signal receiver, method for programming a time signal receiver, and programming device for time signal receivers, is provided. The programmable time signal receiver has receiver for receiving an electromagnetic time signal and a programming signal, as well as processor, configured to process the time signal and the programming signal, whereby the receiver and/or the processor are assigned a memory, configured for temporary storage of programming instructions and for supplying the programming instructions to the receiver and/or to the processor. The programmable time signal receiver also has a controller, which are configured to supply a programming control signal supplied by the receiver and/or by the processor and/or by the memory.

This nonprovisional application claims priority to German Patent Application No. DE 102006060925, which was filed in Germany on Dec. 20, 2006, and to U.S. Provisional Application No. 60/876,530, which was filed on Dec. 22, 2006, and which are both herein incorporated by reference.

### BACKGROUND OF THE INVENTION

1. Field of the Invention

The present invention relates to a programmable time signal receiver, a method for programming a time signal receiver, and a programming device for time signal receivers.

2. Description of the Background Art

The provision of precise time information is of basic importance for many applications in daily life. In various countries such as the USA, Japan, Russia, Germany, etc., precise time signals, which can be received by suitable receivers (time signal receivers), are provided by the appropriate national organizations. The time signals can be used for further processing, i.e., for the extraction of precise time information in appropriately equipped end devices, particularly in radio-controlled clocks or time-based measuring devices.

Radio waves, particularly in the long-wave frequency range from about 30 kHz to about 300 kHz, are a suitable medium for transmitting time signals. In the case of long-wave signals, particularly by amplitude modulation, encoded time signals have a very broad range; they penetrate into buildings and can still be received with very small ferrite antennas. Obstacles such as trees and buildings cause high signal attenuation in the case of high-frequency satellite signals, but such obstacles have only a slight impact on the reception of long-wave signals.

The time signal is provided by a time signal transmitter, which transmits a signal sequence according to a predefined protocol. The national time signal transmitters differ both in the selected transmission frequency and in the configuration of the protocol. An example of a time signal transmitter is the long-wave transmitter DCF77 managed by the Physikalisch Technische Bundesanstalt (PTB) [Federal Physical and Technical Institute], which is controlled by several atomic clocks and transmits a time signal with a power of 50 KW at the frequency of 77.5 kHz during continuous operation. A more detailed description of the protocol for the time signal transmitted by the DCF77 station is the description provided hereinafter of FIGS. 1 and 2. Examples of other time signal transmitters are WWVB (USA), MSF (Great Britain), JJY (Japan), and BPC (China), which transmit time information on a long-wave frequency within the range of between 40 and 160 KHz by means of amplitude-modulated signals.

In general, to transmit time information, a time signal is transmitted within a time frame which is precisely 1 minute long. This time frame contains values for the minute, hour, calendar day, day of the week, month, year, etc., in the form of BCD codes (binary coded decimal codes), which are transmitted with a pulse duration modulation at 1 Hz per bit. In this case, either the rising or falling edge of the first pulse of a time frame is synchronized precisely with 0 seconds. A typical radio-controlled clock is made so that the setting of time occurs by receiving the time information of one or a plurality of time frames from the point in time onward at which the zero second signal was first received.

FIG. 1 shows the coding scheme, designated by the reference character A, of the coded time information according to the protocol of time signal transmitter DCF77. The coding scheme in the present case consists of 59 bits, each 1 bit corresponding to a second of the time frame. Over the course of a minute, a so-called time signal telegram, containing information on the time and date in binary coded form, can be transmitted therewith. The first 15 bits B contain a general coding, for example, operating information, and are not used at present. The next 5 bits C contain general information. Thus, the letter R designates the antenna bit, and A1 designates an announcement bit for the transition from Central European Time (MEZ) to Central European Summer Time (MESZ) and back again. Bits Z1 and Z2 designate time zone bits. A2 designates an announcement bit for a switching second and S designates a start bit for the encoded time information. Starting with bit 21 and up to bit 59, the time and data information are transmitted with a BCD code, whereby the data apply respectively to the next minute. The bits in area D contain information on the minute, in area E information on the hour, in area F information on the calendar day, in area G information on the day of the week, in area H information on the month, and in area I information on the calendar year. This information is provided in a bit-by-bit fashion in an encoded form. So-called test bits P1, P2, P3 are provided respectively at the ends of areas D, E, and 1. The sixtieth bit is vacant and serves to indicate the start of the next frame. M designates the minute mark and thus the start of the time signal.

The structure and bit allocation of the coding scheme, shown in FIG. 1, for transmitting time signals are generally known and described, for example, in an article by Peter Hetzel, “Time Information and Normal Frequency,” Telecom Praxis, Vol. 1, 1993.

The time signal information is transmitted amplitude modulated with the aid of individual second markers. The modulation comprises a reduction X1, X2 or an increase in the carrier signal X at the beginning of each second, whereby at the beginning of each second—with the exception of the fifty-ninth second of each minute—in the case of a time signal transmitted by the DCF77 transmitter, the carrier amplitude is reduced for 0.1 seconds X1 or for 0.2 seconds X2 to about 25% of the amplitude. These reductions of different duration each define a second marker or databit. This different duration of the second markers is used for the binary coding of the clock time and date, whereby second markers X1 with a duration of 0.1 seconds correspond to the binary “0” and those X2 with a duration of 0.2 seconds to the binary “1.” The absence of the sixtieth second marker announces the next minute marker. An evaluation of the time information sent by the time signal transmitter may then be performed in combination with the respective second. Using an example of a section, FIG. 2 shows this type of amplitude-modulated time signal, in which the encoding occurs by a reduction of the HF signal with a different pulse length.

Conventional time signal receivers, as they are described, for example, in the Unexamined German Patent Application No. DE 35 16 810 C2, receive the amplitude-modulated time signal emitted by the time signal transmitter and output it again demodulated as variably long pulses. This occurs in real time; i.e., a variably long pulse is generated per second at the output corresponding to the idealized time signal according to FIG. 2. In this case, the time information is thereby available encoded by the variably long pulses of the carrier. These pulses of different length are supplied by the time signal receiver to a microcontroller connected downstream. The microcontroller evaluates these pulses and determines whether corresponding to the length of this pulse a bit value of “1” or “0” is assigned to the specific pulse. This occurs by determining first the second beginning of a particular time frame of the time signal. If this second beginning is known, the bit value “1” or “0” can then be determined each time from the determined duration of the pulse. The microcontroller now takes up in sequence all 59 bits of a minute and based on the bit encoding of a specific second pulse determines which precise time and which precise date are present.

A time signal receiver made as a radio-controlled clock with a radio-controlled clockwork is known from the market, which is set up for receiving a time signal. To be able to adapt the radio-controlled clockwork to different operating conditions and optionally to enable blocking or release of functions of the radio-controlled clockwork, the radio-controlled clockwork is made programmable. That is to say, one or more programming instructions, which are encoded according to a programming protocol stored in the radio-controlled clockwork, can be fed to the radio-controlled clockwork. After the programming instructions are fed in, they are decoded in the radio-controlled clockwork and processed to bring about the desired properties in the radio-controlled clockwork.

Both the supplying of the programming instructions and their decoding and processing are carried out at a processing speed input in the time signal receiver and matched to the data rate of the time signal. Programming of a time signal receiver is typically realized with a wired feeding of programming instructions into the time signal receiver and occurs at a data rate or transmission rate that is selected in correspondence to the time signal data rate. In other words, a certain time interval is needed for the transmission of programming instructions in a time signal receiver, adjusted to a typical time signal transmitter. This time interval becomes troublesome, particularly in the programming of time signal receivers in mass production, and limits the number of time signal receivers that can be programmed within a unit time.

### SUMMARY OF THE INVENTION

It is therefore an object of the present invention to provide a programmable time signal receiver, a method for programming a time signal receiver, and a programming device for time signal receivers, which enable a more rapid and more reliable programming.

The programmable time signal receiver of the invention has receiver for receiving an electromagnetic time signal and a programming signal, as well as processor for processing the time signal and the programming signal, whereby the receiver and/or the processor are assigned memory, configured for temporary storage of programming instructions and for supplying the programming instructions to the receiver and/or to the processor. In addition, controller are provided, which are configured to supply a programming control signal supplied by the receiver and/or by the processor and/or by the memory. The programming control signal is output to confirm a successful run of a programming process and therewith enables a check whether the programming instructions supplied by a programming device were successfully decoded and also processed.

It is provided in an embodiment of the invention that the controller are set up for wireless transmission of the programming control signal, particularly at a frequency of the time signal and/or the programming signal. Feedback from the time signal receiver in the programming device can be realized as a result in a simple manner without the need for electric or electromechanical coupling between the time signal receiver and the programming device. In an advantageous embodiment of the invention, it is provided that the programming control signal is transmitted to the programming device at the frequency at which the time signal and/or the programming signal is transmitted. This is an advantage, because the programming device is designed in any event for the processing of signals with this (these) frequency (frequencies) and thereby no additional devices are necessary for receiving the programming control signal.

It is provided in another embodiment of the invention that the controller are set up for wireless transmission of the programming control signal by means of receiver, particularly by means of an antenna device assigned to the receiver. An especially efficient feedback of a programming control signal to the programming device can be brought about by using the receiver of the time signal receiver, which in any event are set up for processing time signals and programming signals. The receiver are optimized in their design or their layout to the frequency of the time signal and the programming signal. Thus, for a wireless output of the programming control signal during use of the receiver only a minimum amount of power is required, because good efficiency of programming control signal transmission is assured by the optimization of the receiver. Because time signal receivers are often provided for operation with batteries or similar power storage devices with a limited power capacity, the programming control signal can be output with low power consumption by using the receiver.

Another embodiment of the invention provides that the controller have switching means, which are configured to supply the programming control signal to an antenna device depending on a switching signal. A high-impedance switching signal, which is supplied by processor configured as a state machine, particularly as a microcontroller, can be converted with the switching means into a programming control signal, which is transmitted by the antenna device.

It is provided in another embodiment of the invention that the controller are set up for wired transmission of the programming control signal. This is particularly of interest when wired transmission of the programming instructions is also provided.

According to another aspect of the invention, a method for programming a time signal receiver with the following steps is provided: provision of at least one programming instruction to a time signal receiver by means of a programming device, decoding of the programming instruction by receiver and/or by processor of the time signal receiver, storage of the programming instruction, designated for execution in the receiver and/or in the processor, in the memory of the time signal receiver, outputting a programming control signal during and/or after the carrying out of the programming process by means of the time signal receiver, and receiving and processing of the programming control signal in the programming device. By means of this type of method, feedback of the time signal receiver can be transmitted to the programming device, which provides information whether the programming process triggered by the programming device is being or was carried out successfully in the time signal receiver. This is of particular interest when data that are to control security-relevant functions of the time signal receiver are transmitted with the programming instructions to the time signal receiver. For this case, it can also be provided that the time signal receiver transmits the data in a processed, particularly encrypted, form again back to the programming device, so that precise control of the transmitted data is possible. The programming control signal can be output after each programming instruction, preferably after a sequence of programming instructions with predefinable length, especially preferably after the end of the programming process.

It is provided in another embodiment of the invention that the programming instructions are supplied at a data rate that is selected higher than the data rate of the time signal, whereby the time signal receiver is supplied with a programming clock frequency which is adjusted to the data rate and is selected as higher than the internal working clock frequency of the time signal receiver. As a result, acceleration of the programming process is made possible in that the internal processing speed of the time signal receiver, which is designed for the low data rate of the time signal and for low power consumption, is overridden by means of the programming clock frequency and thereby increased. For the time signal receiver, adjustment to a higher data rate is therefore achieved by which appropriate programming instructions can be supplied at a higher speed by the programming device, with the aid of the programming clock frequency, which is selected higher than the internal working clock frequency. It is possible to achieve a halving of the programming time even at a programming clock frequency, which is selected as twice as high as the working clock frequency. This is of particular interest when many time signal receivers are to be programmed during mass production. A short programming time is desired also when programming of a time signal receiver, which is provided in an end user device, such as a wristwatch, a household device, or another device, is to occur with end-customer-specific data, for example, at the cash register in a retail store. The programming clock frequency is preferably selected so that an advantageous compromise between a short programming time and a reliable run of the programming process is assured. Due to its structure or its layout, the time signal receiver does not permit any increase desired in the working clock frequency. Preferably, at least a doubling, especially preferably a quadrupling, particularly a tenfold increase, of the working clock frequency is provided.

The programming control signal provides the possibility of monitoring the programming process and, in the event of faulty programming, to carry out a reduction in the programming clock frequency and the programming data rate to assure a reliable programming result.

It is provided in another embodiment of the invention that in sequential programming processes a subsequent programming process is carried out with a programming clock frequency that is selected higher than a programming clock frequency of a preceding programming process, provided the previous programming process was carried out properly. Determination of an optimal programming speed for the time signal receiver can be performed therewith over many successive programming processes. This is of interest in the mass production of time signal receivers, because different batches of time signal receivers can differ due to variation in the production processes also with respect to their maximum programming speed or maximum data rate and therewith a dynamic adjustment of the programming clock frequency to the properties of the time signal receiver is possible. If a time signal receiver that is to be programmed next cannot be successfully programmed with the preceding programming clock frequency, the programming clock frequency and the data rate are reduced for the programming instructions.

Another embodiment of the invention provides that the programming clock frequency is provided by the programming device. This makes it possible to supply several programming clock frequencies with a minor frequency difference, so that an advantageous adjustment to the properties of the time signal receiver can be realized without corresponding devices having to be provided for this in the time signal receiver.

According to another aspect of the invention, a programming device for programming a time signal receiver is provided, which has memory for storing programming instructions for the time signal receiver, an internal clock generator for supplying a programming clock frequency for programming the time signal receiver with an increased clock frequency, a control device for supplying the programming instructions to the time signal receiver and to the receiver for a programming control signal transmitted by the time signal receiver during and/or after the programming process. An advantageous adjustment of the programming clock frequency and of the data rate for the programming instructions can be realized with the programming control signal supplied by the time signal receiver in the control device of the programming device. Preferably, the control device is set up in such a way that a subsequent programming process is performed with a higher programming clock frequency, provided that a predefinable number of programming control signals was received by the receiver in a preceding programming process. In this case, the number of predefinable programming control signals to be received can be selected so that only a minimum number of programming control signals must be received to assess the programming process as successful. In the programming of security-relevant programming instructions, a 100% testing using the programming control signals output by the time signal receiver can be provided, so that an increase in the programming clock frequency occurs only when all programming instructions to be checked were confirmed as positive also by the feedback of the corresponding programming control signals to the programming device. It can also be provided, further, that the programming clock frequency and the data rate for transmitting the programming instructions are reduced, when a programming process was not successfully completed. In this case, a renewed programming of the previously programmed time signal receiver occurs before a subsequent time signal receiver is programmed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic graphic depiction of a time signal, which is encoded

according to the protocol of the time signal transmitter DCF77;

FIG. 2 shows part of an idealized time signal with 5 second pulses;

FIG. 3 shows a block diagram of a time signal receiver in greatly simplified form;

FIG. 4 shows a detailed block diagram of part of the time signal receiver according to

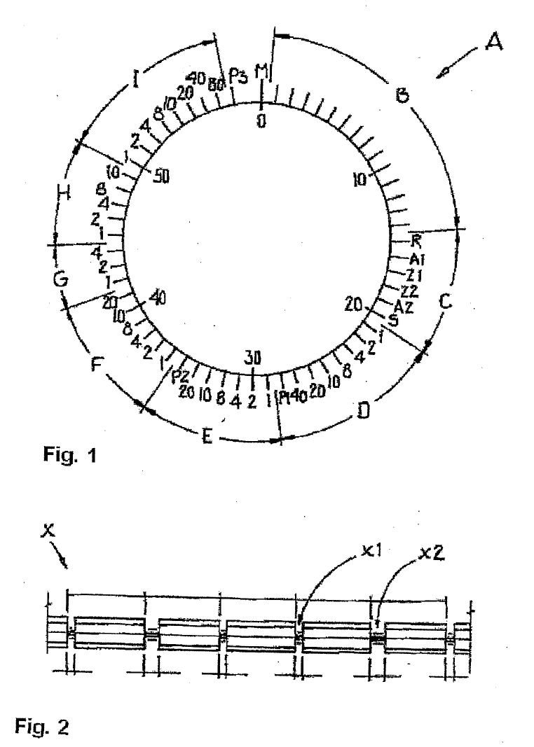

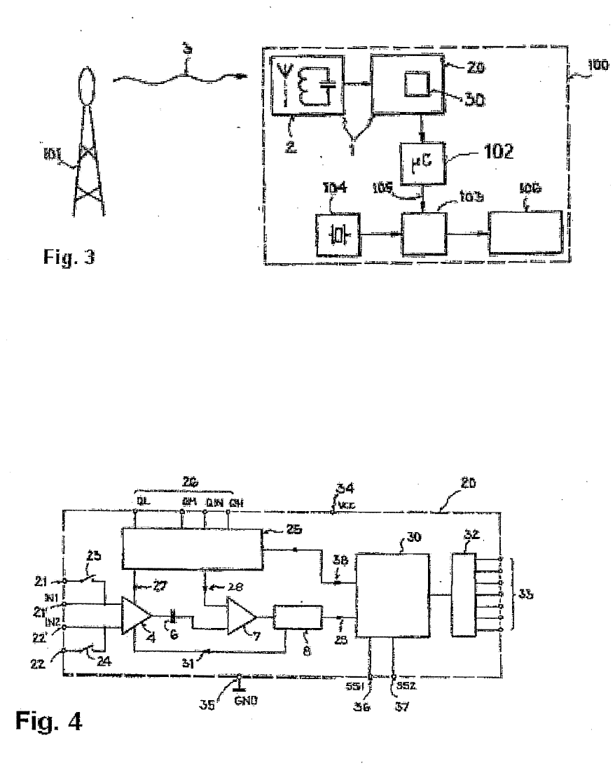

FIG. 3;

FIG. 5 shows a schematic drawing of a programming device, which is set up for

wireless supplying of an external programming clock signal and for receiving a programming control signal; and

FIG. 6 shows a schematic drawing of a control device for wireless transmission of a

programming control signal.

### DETAILED DESCRIPTION

The same or functionally equivalent elements, signals, and functions, if not indicated otherwise, are designated with the same reference characters in all figures of the drawing.

The basic structure and operating mode of a time signal receiver are known from German Unexamined Patent Application No. DE 35 16 810. FIG. 3 shows a block diagram of a greatly simplified time signal receiver, which is formed in the present case as radio-controlled clock 100. Radio-controlled clock 100 has an antenna 2 for picking up time signal 3 transmitted by a time signal transmitter 101. An integrated circuit 20 with a logic and control unit 30 is connected to antenna 2. Antenna 2 and integrated circuit 20 together form receiver 1. A program-controlled unit, made as microcontroller 102 in the form of processor, is connected downstream of the outputs of receiver 1. Microcontroller 102 takes up the databits generated by the receiver, calculates a precise time and date from these, and generates therefrom a signal 105 for the time and date. Radio-controlled clock 100, further, has an electronic clock 103 whose time is controlled by a clock crystal 104. Electronic clock 103 is connected to an indicator 106, for example, a display, by which the time is indicated.

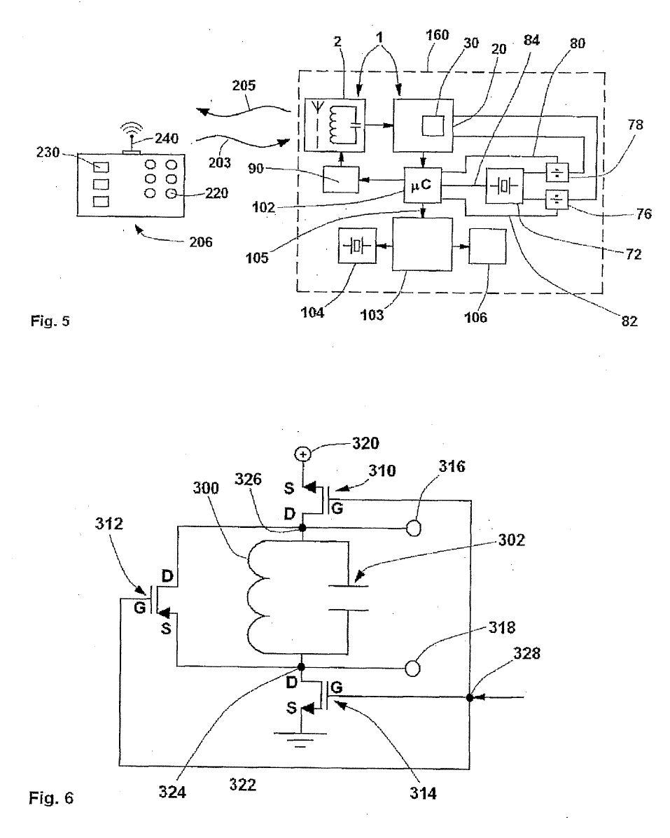

FIG. 4, using a detailed block diagram, shows the time signal receiver part, made as integrated circuit 20. Integrated circuit 20 has two inputs 21, 22 for connection to one or two antennas, which are not shown. By providing two or more antennas, it is possible to tune receiver 1 to different time signal transmitters, which operate in different wavelengths ranges, by switching between the antennas. Switching can be used for a frequency or antenna switch. A control amplifier 4 can be connected to one of the antenna inputs 21, 22 each by controllable switches 23, 24. The other input of control amplifier 4 is connected to inputs 21′, 22′. A reference signal IN1, IN2, for example, can be coupled into these inputs. Control amplifier 4 is connected on the output side to an input of a postamplifier 7. A filter 6, which is formed as a capacitor and with which parasitic capacitances between inputs QL-QH can be compensated, is disposed in-between.

Integrated circuit 20 further has a switching unit 25. Switching unit 25 has, for example, a plurality of switchable filters at inputs QL-QH, by means of which switching unit 25 is designed to provide several frequencies on the output side. These frequencies can be set via control inputs 26, 36, 37 of switching unit 25. Control amplifier 4 can be influenced, particularly controlled, by control signal 27 provided by switching unit 25. Switching unit 25 further generates an output signal 28, which is coupled into a second input of postamplifier 7. Postamplifier 7 controls rectifier 8 connected downstream. Rectifier 8 generates a control signal 31 (AGC signal=Automatic Gain Control), which controls control amplifier 4. Rectifier 8 on the output side further generates an output signal 29, for example, a rectangular output signal 29 (TCO signal), which is supplied to a logic and control unit 30 connected downstream.

Logic and control unit 30 is connected to an input/output device 32 (I/O unit), which is connected to input/output terminals 33 of integrated circuit 20. At these terminals 33 the time signals can be tapped that, inter alia, are processed, decoded, and stored in logic and control unit 30. A microcontroller, connected downstream of integrated circuit 20 and not shown in FIG. 4, or a state machine with a rather simple structure, if required, can read out these time signals just stored and decoded in logic and control unit 30. A clock signal can be supplied via terminals 33 to integrated circuit 20 or logic and control unit 30.

For further control of switching unit 25, said unit is connected to logic and control unit 30 and controls logic and control unit 30 with a control signal 38. The integrated circuit further has terminals 36, 37, via which logic and control unit 30 can be supplied with control signals SS1, SS2.

Programming device 206 shown in FIG. 5 is provided for wireless transmission of programming instructions and has an antenna 240, which makes possible the sending out of electromagnetic signals to time signal receiver 160 without a mechanical connection between programming device 206 and time signal receiver 160. Programming device 206 is equipped with a control device (not shown) and memory and with receiver for the programming control signal.

Time signal receiver 160 is fitted out with an internal clock generator 72 formed as a quartz oscillator, which is provided for supplying a basic clock signal. Internal clock generator 72 is assigned two schematically shown frequency dividers 76 and 78, which have different divider ratios and thus can derive a working clock frequency or a programming clock frequency from the basic clock frequency of integrated clock generator 72 and relay it to receiver 1.

Microcontroller 102 is connected via a control line 84 to integrated clock generator 72 and therewith enables an activation or deactivation of internal clock generator 72. A deactivation of internal clock generator 72 can be provided when programming device 206 wirelessly transmits, apart from programming instructions, also an external clock signal, which can be coupled via antenna 2 into receiver 1 and into microcontroller 102.

If no corresponding programming clock signal is supplied by programming device 206, internal clock generator 72 remains activated during the programming process. Upon arrival of an appropriate programming instruction, first frequency divider 76, configured to supply the working clock signal, is deactivated by microcontroller 102 and second frequency divider 78, provided for supplying the programming clock signal, is activated. As a result, the higher programming clock frequency is provided at receiver 1 and thereby also at microcontroller 102 and receiving of programming instructions of programming device 206 can occur at a data rate that is higher than the data rate of the time signal.

Microcontroller 102 is assigned controller 90, which are provided for controlling antenna 2 and which enable wireless transmission of a programming control signal, which can be supplied by microcontroller 102, to programming device 206. The transmission of the programming control signal as an electromagnetic wave is indicated by arrow 205. Programming device 206 is set up for receiving and processing of the programming control signal and therewith can bring about an increase or reduction in the data rate, with which the programming instructions are transmitted to time signal receiver 160, during and/or after the carrying out of a programming process. Preferably, the programming clock frequency is supplied by programming device 206, because this device can hold ready a larger variety of different programming clock frequencies for adjustment to the maximum data rate of the time signal receiver.

FIG. 6 shows an enlarged section of a region of receiver 2 according to FIG. 5, whereby controller 90, shown as a separate block in FIG. 5, can be represented at least substantially by the three MOS transistors 310, 312 and 314 and by the associated control lines. Integrated circuit 20 and control unit 30 of receiver 1 are not shown in FIG. 6 for reasons of simplicity. Connection points 316 and 318 for electric coupling to the integrated circuit and the control unit are shown, however.

Antenna 2 has a coil 300 and a capacitor 302, which are connected parallel to one another. In each case, connection points 316 and 318, which are provided for relaying a signal coupled inductively from outside by electromagnetic waves to the integrated circuit and to the control device, are coupled electrically at common nodal points 324, 326 of coil 300 and capacitor 302. Current terminals (source terminal S and drain terminal D) of PMOS transistor 312 are connected at nodal points 324 and 326; in a conducting state, said transistor is capable of short-circuiting nodal points 324 and 326 and therewith avoiding a postoscillation of the resonant circuit formed by coil 300 and capacitor 302.

A current terminal (drain terminal D) of NMOS transistor 314, whose other current terminal (source terminal S) is connected to a ground terminal 322, is connected moreover at nodal point 324. A current terminal (source terminal S) of NMOS transistor 310, whose other current terminal (drain terminal D) is connected to a voltage source, is connected at nodal point 326. The control terminals (gate terminals G) of all transistors 310, 312, 314 are joined at a common nodal point 328, at which a signal supplied by microcontroller 102 for controlling the transistors can be coupled. When the signal supplied by microcontroller 102 is at a logic low level, both NMOS transistors 310 and 314 are blocked, because no positive control voltage is applied between the associated control terminals G and current terminals S.

PMOS transistor 312 is released due to the low level of the control signal, i.e., in an electrically conductive manner, and can therewith reduce a voltage difference between nodal points 324 and 326, so that a postoscillation of the resonant circuit comprising coil 300 and capacitor 302 is prevented. During application of a logic high level at NMOS transistors 310 and 314, therefore a control voltage, which is greater than a threshold voltage of NMOS transistors 310, 314, a positive control voltage is present between control terminals G of NMOS transistors 310, 314 and the specifically assigned current terminals S, so that the two NMOS transistors 310, 314 are connected in a conductive manner. Thereby, typically only for a short time, the electric voltage, applied between the voltage source and ground terminal 322, is applied at coil 300 and at capacitor 302 and causes coil 300 to emit an electromagnetic pulse. This electromagnetic pulse can be received by programming device 206, shown in FIG. 5, as a programming control signal.

Depending on the type of the predefinable protocol for the programming control signal, a pulse sequence can be transmitted wirelessly to programming device 206 by application of a sequence of logic low and high signals at the control device. The pulse sequence can be evaluated in programming device 206 and assessed as confirmation of a successfully completed programming process. Next, depending on incoming programming control signals, an increase or reduction of a programming clock frequency and a data rate for programming instructions can be realized.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A programmable time signal receiver comprising:
a receiver configured to receive an electromagnetic time signal and a programming signal;
a processor configured to process the time signal and the programming signal, the receiver and/or the processor being assigned a memory, configured for temporary storage of programming instructions and for supplying the programming instructions to the receiver and/or to the processor; and
a controller configured to supply a programming control signal supplied by the receiver and/or by the processor and/or by the memory.

2. The programmable time signal receiver according to claim 1, wherein the controller is set up for wireless transmission of the programming control signal, particularly at a frequency of the time signal and/or the programming signal.

3. The programmable time signal receiver according to claim 2, wherein the controller is set up for wireless transmission of the programming control signal by the receiver, particularly by an antenna device assigned to the receiver.

4. The programmable time signal receiver according to claim 3, wherein the controller has a switch, which is configured to supply the programming control signal to an antenna device depending on a switching signal.

5. The programmable time signal receiver according to claim 1, wherein the controller is set up for wired transmission of the programming control signal.

6. A method for programming a time signal receiver comprising:
providing at least one programming instruction to a time signal receiver by a programming device;
decoding the programming instruction by receiver and/or by processor of the time signal receiver;
storing the programming instruction, designated for execution in the receiver and/or in the processor, in the memory of the time signal receiver;
outputting a programming control signal during and/or after the carrying out of the programming process by the time signal receiver; and
receiving and processing of the programming control signal in the programming device.

7. The method according to claim 6, wherein the programming control signal is output after each programming instruction, preferably after a sequence of programming instructions with predefinable length, especially preferably after the end of the programming process.

8. The method according to claim 6, wherein the programming instructions are provided at a data rate that is selected higher than the data rate of the time signal, whereby the time signal receiver is supplied with a programming clock frequency adjusted to the data rate, which is selected as higher than an internal working clock frequency of the time signal receiver.

9. The method according to claim 8, wherein in sequential programming processes a subsequent programming process is carried out with a programming clock frequency that is selected higher than a programming clock frequency of a preceding programming process, provided the previous programming process was carried out properly.

10. The method according to claim 9, wherein the programming clock frequency is supplied by a programming device.

11. A programming device for programming a time signal receiver, the device comprising:
a memory for storing programming instructions for the time signal receiver;
an internal clock generator for supplying a programming clock frequency for programming the time signal receiver with an increased clock frequency;
a control device, which is set up to supply the programming instructions to the time signal receiver; and
a receiver for a programming control signal transmitted by the time signal receiver during and/or after the programming process.

12. The programming device according to claim 11, wherein the control device is set up in such a way that a subsequent programming process is performed with a higher programming clock frequency, provided that a predefinable number of programming control signals was received by the receiver in a preceding programming process.
